(19) United States
(12) Patent Application Publication
(10) Pub. No.: US 2014/0218571 A1
(43) Pub. Date: Aug. 7, 2014

(54) IMAGE PROCESSING METHOD CAPABLE OF REDUCING IMAGE NOISE

(71) Applicant: Etron Technology, Inc., Hsinchu (TW)

(72) Inventor: Shin-Shiuan Cheng, Taipei City (TW)

(73) Assignee: Etron Technology, Inc., Hsinchu (TW)

(21) Appl. No.: 14/160,507

(22) Filed: Jan. 21, 2014

(30) Foreign Application Priority Data
Feb. 4, 2013 (TW) 102104234

(51) Int. Cl. G06T 5/00; H04N 9/04

(52) U.S. Cl. CPC G06T 5/002; H04N 9/04
USPC 348/273; 382/274

(57) ABSTRACT

An image processing method includes searching a plurality of reference image blocks with pixel patterns identical to a pixel pattern of a main image block in image data; generating a plurality of weight values according to brightness values of pixels of the main image block and brightness values of pixels of the plurality of reference image blocks; summing values of multiplying the plurality of weight values with brightness values of center pixels of the corresponding main image block and the corresponding reference image blocks to generate a sum result; generating a first brightness value according to the sum result and a normalizing factor; and updating the brightness value of the center pixel of the main image block according to the first brightness value.

### BACKGROUND OF THE INVENTION

1. Field of the Invention

The present invention relates to an image processing method, and more particularly, to an image processing method capable of reducing image noise.

2. Description of the Prior Art

As related technology keeps improving, digital image technique is gradually and widely applied to various kinds of electronic devices, such as digital cameras or digital camcorders. The digital image technique utilizes a light sensing element for sensing external light in order to generate image data. Each of digital images is composed of a plurality of red, green and blue pixels, and brightness values of the pixels correspond to intensity of light sensed by the light sensing element. Since the image data is generated according to electrical signals of the light sensing element, a brightness value of each pixel in an image is a result of an original brightness value plus image noise. The image noise is random and unpredictable, thus it is very difficult to completely remove the image noise from the image data. However, when the image noise is very big, the image noise may seriously affect quality of the digital image, and even blur the digital image. Therefore, it is a very important topic to reduce the image noise for improving quality of the digital image in current digital image technique.

### SUMMARY OF THE INVENTION

The present invention provides an image processing method capable of reducing image noise, the image processing method comprises searching a plurality of reference image blocks with pixel patterns identical to a pixel pattern of a main image block in image data; generating a plurality of weight values according to brightness values of pixels of the main image block and brightness values of pixels of the plurality of reference image blocks; summing values of multiplying the plurality of weight values with brightness values of center pixels of the corresponding main image block and the corresponding reference image blocks to generate a sum result; generating a first brightness value according to the sum result and a normalizing factor; and updating the brightness value of the center pixel of the main image block according to the first brightness value.

The present invention further provides an image capturing system capable of reducing image noise. The image capturing system comprises a color filter array, an image sensor, and an image processor. The color filter array is configured to filter light. The image sensor is configured to generate image data by sensing light passing through the color filter array. The image processor is coupled to the image sensor for receiving the image data, searching a plurality of reference image blocks with pixel patterns identical to a pixel pattern of a main image block in the image data, generating a plurality of weight values according to brightness values of pixels of the main image block and brightness values of pixels of the plurality of reference image blocks, summing values of multiplying the plurality of weight values with brightness values of center pixels of the corresponding main image block and the corresponding reference image blocks to generate a sum result, generating a first brightness value according to the sum result and a normalizing factor, and updating the brightness value of the center pixel of the main image block according to the first brightness value.

The present invention further provides an image processor capable of reducing image noise. The image processor comprises an input/output interface, and a processing unit. The input/output interface is configure to receive image data. The processing unit is configure to search a plurality of reference image blocks with pixel patterns identical to a pixel pattern of a main image block in the image data, generate a plurality of weight values according to brightness values of pixels of the main image block and brightness values of pixels of the plurality of reference image blocks, sum values of multiplying the plurality of weight values with brightness values of center pixels of the corresponding main image block and the corresponding reference image blocks to generate a sum result, generate a first brightness value according to the sum result and a normalizing factor, and update the brightness value of the center pixel of the main image block according to the first brightness value.

In contrast to the prior, the present invention provides an image processing method capable of reducing image noise. The image processing method of the present invention calculates corresponding weight values according to similarity between the main image block and the reference image block, and further obtains a new brightness value of the center pixel of the main image block, such that the new brightness value of the center pixel is a result of an original brightness value plus averaged image noise, so as to significantly reduce the image noise of the original image captured by the image capturing system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an image capturing system of the present invention.

FIG. 2 is a diagram showing pixel arrangement of image data.

FIG. 3 is a flowchart showing an image processing method of the present invention.

### DETAILED DESCRIPTION

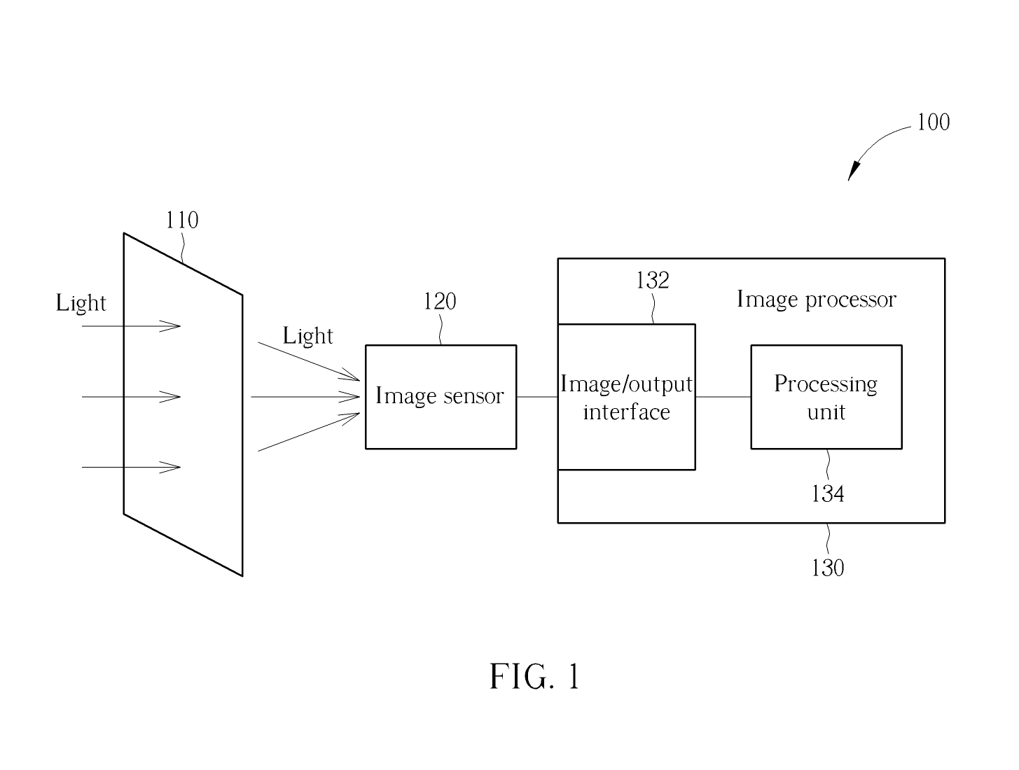

Please refer to FIG. 1. FIG. 1 is a diagram showing an image capturing system 100 of the present invention. As shown in FIG. 1, the image capturing system 100 of the present invention comprises a color filter array 110, an image sensor 120, and an image processor 130. The color filter array 110 is configured to filter light. The image sensor 120 is configured to generate image data by sensing light passing through the color filter array 110. The image processor 130 comprises an input/output interface 132, and a processing unit 134. The input/output interface 132 is coupled to the image sensor 120 for receiving the image data generated by the image sensor 120. The processing unit 134 is configured to perform image processing to the image data.

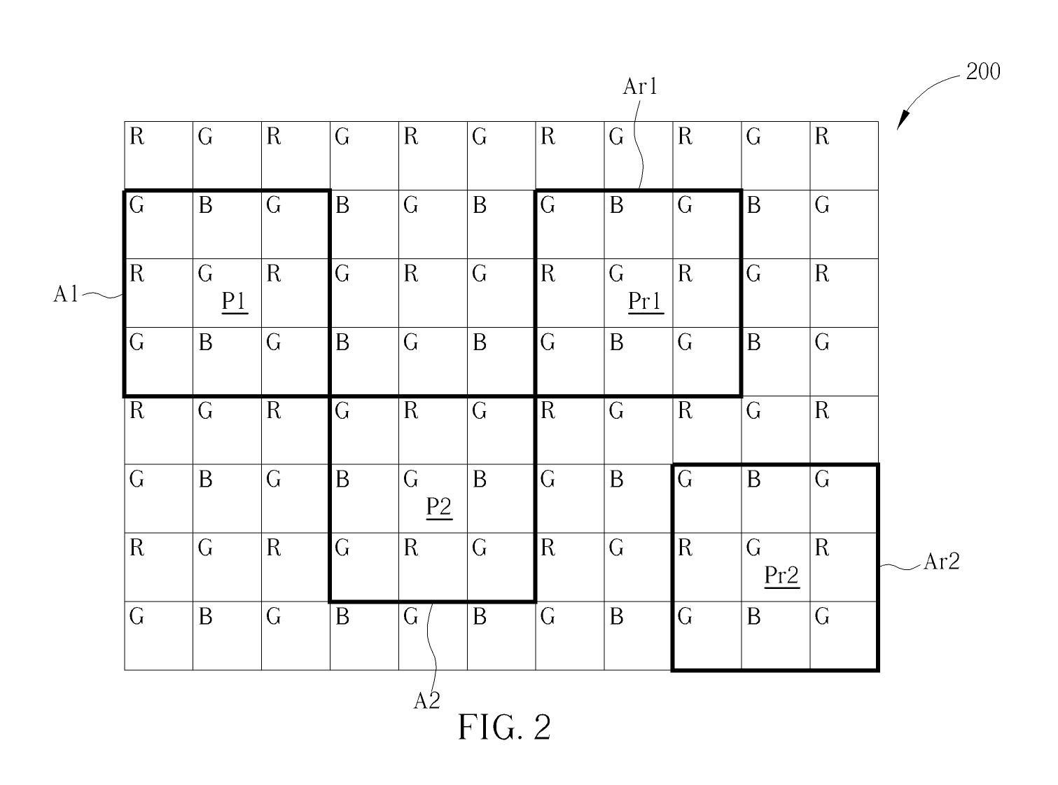

Please refer to FIG. 2, and refer to FIG. 1 as well. FIG. 2 is a diagram showing pixel arrangement of the image data 200. As shown in FIG. 2, the image data 200 is composed of a plurality of red pixels R, green pixels G and blue pixels B arranged to form a color digital image. Pixel arrangement in FIG. 2 is for illustrating an image processing method of the present invention, the image processing method of the present invention can be applied to image data with other pixel arrangement. In the image processing method of the present invention, in order to reduce image noise of a pixel P1, the image processor 130 first searches a plurality of reference image blocks Ar1, Ar2 with pixel patterns identical to a pixel pattern of a main image block A1 according to the pixel pattern of the main image block A1 having a center pixel P1 (the marked reference image blocks Ar1, Ar2 are for examples, the image data 200 contains more reference image blocks). Center pixels Pr1, Pr2 of the reference image blocks Ar1, Ar2 have a same color as the center pixel P1 of the main image block A1. In another image block A2, although a center pixel P2 has the same color as the center pixel P1 of the main image block A1, but pixel pattern of the image block A2 is different from the pixel pattern of the main image block A1, thus the image block A2 cannot be a reference image block. Thereafter, the image processor 130 respectively compares brightness values of all pixels of the main image block A1 with brightness values of all pixels of the reference image blocks Ar1, Ar2 in order to generate weight values. For example, the image processor 130 respectively deducts the brightness values of all pixels of the reference image block Ar1 or Ar2 from the corresponding brightness values of all pixels of the main image block A1 (such as deducts a brightness value of a pixel at upper left corner of the reference image block Ar1 or Ar2 from a brightness value of a pixel at upper left corner of the main image block A1), and further generates a weight value according to a Gaussian function. The weight value can be obtained according to the following equation:

$${e}^{- \frac{( {G}_{a} * {\vert u ( x + . ) - u ( y + . ) \vert}^{2} ) ( 0 )}{{h}^{2}}} \qquad ( 1 )$$

where Ga is the Gaussian function, u(x+.) is the brightness value of each pixel of the main image block A1, u(y+.) is the corresponding brightness value of each pixel of the reference image blocks Ar1, Ar2, and h is a filtering parameter.

According to equation (1), when each of the brightness values of pixels of the main image block A1 is close to each of the brightness values of corresponding pixels of the reference image block Ar1, Ar2, the weight value is close to 1; and when each of the brightness values of pixels of the main image block A1 is much different from each of the brightness values of corresponding pixels of the reference image block Ar1, Ar2, the weight value is smaller, and even close to 0. In addition, a weight value of the main image block A1 is equal to 1. When the reference image block having a larger weight value, it means an image displayed by the reference image block is more similar to an image displayed by the main image block, thus an original brightness value of the center pixel Pr1, Pr2 of the reference image block Ar1, Ar2 having the larger weight value is closer to an original brightness value of the center pixel P1 of the main image block A1.

After obtaining the weight values, the image processor 130 multiplies the brightness values of center pixels of the main and reference image blocks with corresponding weight values, and sums results of above multiplications to generate a sum result. The sum result can be obtained according to the following equation:

$${\int }_{Ω} {e}^{- \frac{( {G}_{a} * {\vert u ( x + . ) - u ( y + . ) \vert}^{2} ) ( 0 )}{{h}^{2}}} u ( y ) d y \qquad ( 2 )$$

where u(y) is the brightness value of the center pixel P1 of the main image block A1 or the center pixel Pr1, Pr2 of the reference image block Ar1, Ar2, and Ω represents ranges selected in the image data.

After generating the sum result, the image processor 130 generates a first brightness value by dividing the sum result by a normalizing factor. The first brightness value can be obtained according to the following equation:

$$NL [ u ] ( x ) = \frac{1}{C ( x )} {\int }_{Ω} {e}^{- \frac{( {G}_{a} * {\vert u ( x + . ) - u ( y + . ) \vert}^{2} ) ( 0 )}{{h}^{2}}} u ( y ) d y \qquad ( 3 )$$

where C(x) is the normalizing factor, and NL[u](x) is the first brightness value. Dividing the sum result by a normalizing factor is similar a concept of averaging the sum result, thus the first brightness value generated by the equation (3) is close to a value of averaging the result of multiplying the plurality of weight values with brightness values of center pixels P1, Pr1, Pr2 of the corresponding main and reference image blocks A1, Ar1, Ar2, that is, the first brightness value is close to a result of the original brightness value of the center pixel P1 of the main image block A1 plus an averaged image noise. Since the image noise is random, the averaged image noise is much smaller than original image noise. Therefore, the image processor 130 can replace the original brightness value of the center pixel P1 of the main image block A1 with the first brightness value, in order to reduce image noise of the center pixel P1.

In addition, the image processor 130 can further generate a second brightness value by averaging the first brightness value with brightness values of neighborhood pixels of the center pixel P1 of the main image block A1 having a same color as the center pixel P1 of the main image block A1, and then replace the brightness value of the center pixel P1 of the main image block A1 with the second brightness value, such that the image noise of the center pixel P1 can be further reduced.

The image processing method of the present invention can apply the above processes to all (or most) of the pixels of the image data, in order to significantly reduce overall image noise of the image data. In addition, the above equations are examples for illustrating the image processing method of the present invention. In other embodiments of the present invention, the image processing method of the present invention can use other equations to calculate the weight values and the first brightness value.

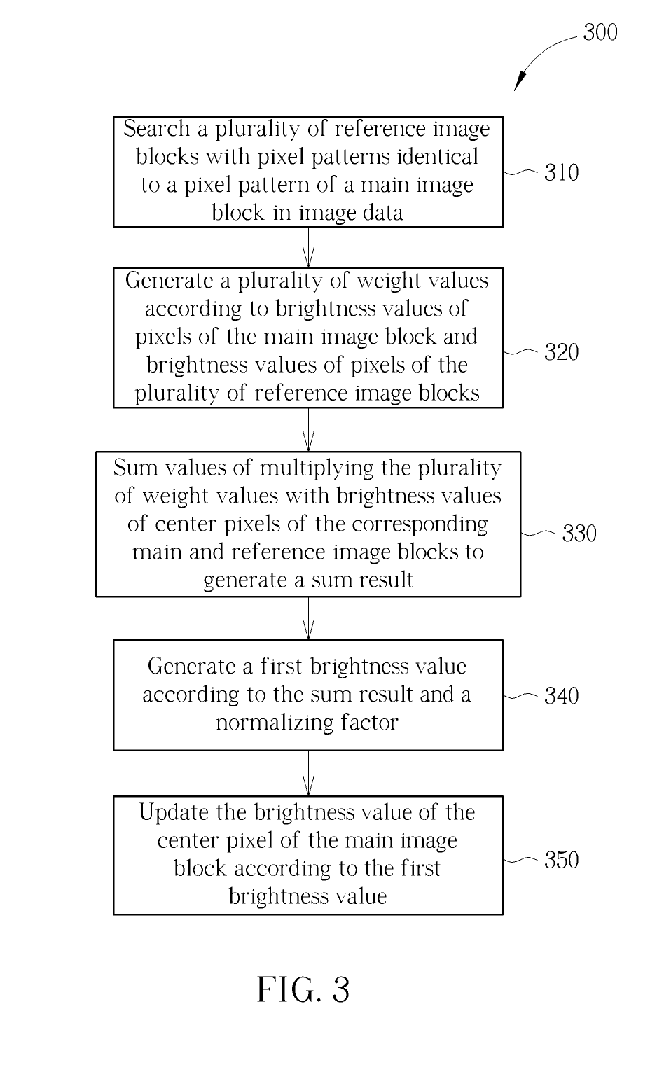

Please refer to FIG. 3. FIG. 3 is a flowchart 300 showing an image processing method of the present invention. The flowchart of the image processing method of the present invention comprises the following steps:

Step 310: Search a plurality of reference image blocks with pixel patterns identical to a pixel pattern of a main image block in image data;

Step 320: Generate a plurality of weight values according to brightness values of pixels of the main image block and brightness values of pixels of the plurality of reference image blocks;

Step 330: Sum values of multiplying the plurality of weight values with brightness values of center pixels of the corresponding main and reference image blocks to generate a sum result;

Step 340: Generate a first brightness value according to the sum result and a normalizing factor; and

Step 350: Update the brightness value of the center pixel of the main image block according to the first brightness value.

In step 310, the way of searching other reference image blocks with pixel patterns identical to the pixel pattern of the main image block in the image data can ensure to find the correct reference image blocks without any mistake, so as to avoid obtaining incorrect first brightness value.

In contrast to the prior, the present invention provides an image processing method capable of reducing image noise. The image processing method of the present invention calculates corresponding weight values according to similarity between the main image block and the reference image block, and further obtains a new brightness value of the center pixel of the main image block, such that the new brightness value of the center pixel is a result of the original brightness value plus the averaged image noise, so as to significantly reduce the image noise of the original image captured by the image capturing system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method capable of reducing image noise, comprising:
searching a plurality of reference image blocks with pixel patterns identical to a pixel pattern of a main image block in image data;
generating a plurality of weight values according to brightness values of pixels of the main image block and brightness values of pixels of the plurality of reference image blocks;
summing values of multiplying the plurality of weight values with brightness values of center pixels of the corresponding main image block and the corresponding reference image blocks to generate a sum result;
generating a first brightness value according to the sum result and a normalizing factor; and
updating the brightness value of the center pixel of the main image block according to the first brightness value.

2. The image processing method of claim 1, wherein generating the first brightness value according to the sum result and the normalizing factor comprises generating the first brightness value by dividing the sum result by the normalizing factor.

3. The image processing method of claim 1, wherein updating the brightness value of the center pixel of the main image block according to the first brightness value comprises replacing the brightness value of the center pixel of the main image block with the first brightness value.

4. The image processing method of claim 1, wherein updating the brightness value of the center pixel of the main image block according to the first brightness value comprises:
generating a second brightness value by averaging the first brightness value with brightness values of neighborhood pixels of the center pixel of the main image block having a same color as the center pixel of the main image block; and
replacing the brightness value of the center pixel of the main image block with the second brightness value.

5. The image processing method of claim 1, wherein the center pixels of the reference image blocks have a same color as the center pixel of the main image block.

6. The image processing method of claim 1, wherein generating the plurality of weight values according to the brightness values of pixels of the main image block and brightness values of pixels of the plurality of reference image blocks comprises generating the plurality of weight values according to a result of comparing the brightness values of pixels of the main image block with the brightness values of pixels of the plurality of reference image blocks and a Gaussian function.

7. An image capturing system capable of reducing image noise, comprising:
a color filter array, configured to filter light;
an image sensor, configured to generate image data by sensing light passing through the color filter array; and
an image processor, coupled to the image sensor for receiving the image data, searching a plurality of reference image blocks with pixel patterns identical to a pixel pattern of a main image block in the image data, generating a plurality of weight values according to brightness values of pixels of the main image block and brightness values of pixels of the plurality of reference image blocks, summing values of multiplying the plurality of weight values with brightness values of center pixels of the corresponding main image block and the corresponding reference image blocks to generate a sum result, generating a first brightness value according to the sum result and a normalizing factor, and updating the brightness value of the center pixel of the main image block according to the first brightness value.

8. The image capturing system of claim 7, wherein the center pixels of the reference image blocks have a same color as the center pixel of the main image block.

9. An image processor capable of reducing image noise, comprising:
an input/output interface, configure to receive image data;
a processing unit, configure to search a plurality of reference image blocks with pixel patterns identical to a pixel pattern of a main image block in the image data, generate a plurality of weight values according to brightness values of pixels of the main image block and brightness values of pixels of the plurality of reference image blocks, sum values of multiplying the plurality of weight values with brightness values of center pixels of the corresponding main image block and the corresponding reference image blocks to generate a sum result, generate a first brightness value according to the sum result and a normalizing factor, and update the brightness value of the center pixel of the main image block according to the first brightness value.

10. The image processor of claim 9, wherein the center pixels of the reference image blocks have a same color as the center pixel of the main image block.
